(19) United States
(12) Patent Application Publication
(10) Pub. No.: US 2019/0184332 A1
(43) Pub. Date: Jun. 20, 2019

(54) HELIUM PURITY ADJUSTMENT IN A MEMBRANE SYSTEM

(71) Applicant: UOP LLC, Des Plaines, IL (US)

(72) Inventors: Tom Cnop, Brussels (BE); Mark E. Schott, Palatine, IL (US); David W. Greer, Cary, IL (US); David Farr, Hoffman Estates, IL (US); Simon E. Albo, Evanston, IL (US)

(21) Appl. No.: 16/164,206

(22) Filed: Oct. 18, 2018

Related U.S. Application Data
(60) Provisional application No. 62/599,571, filed on Dec. 15, 2017.

(51) Int. Cl. B01D 53/22; C01B 23/00; C10L 3/10

(52) U.S. Cl. CPC B01D 53/226; C01B 23/0042; C10L 3/101; C10L 2290/548; C01B 2210/001; C01B 2210/007; C01B 2210/0031

(57) ABSTRACT

A multi-stage membrane system is provided to separate helium from a gas stream such as a natural gas stream. There are at least two permeate streams from a first membrane module. One of the permeate streams is compressed and sent to a second membrane module while one of the permeate streams bypasses the compressor. There are control means provided to determine the flow for these two permeate streams based on factors including the compressor capacity, the concentration of the target component in the combined permeate streams and the capacity of the second membrane module.

### CROSS-REFERENCE TO RELATED APPLICATION

This application claims priority from U.S. Provisional Application No. 62/599,571 filed Dec. 15, 2017, the contents of which cited application are hereby incorporated by reference in its entirety.

### BACKGROUND OF THE INVENTION

The invention relates to a membrane system for recovering helium from a gas stream. More particularly, the invention relates to recovering and producing helium from natural gas.

### BRIEF DESCRIPTION OF THE DRAWING

FIG. 1 shows a two-stage membrane system for removal and recovery of helium from a gas stream.

FIG. 2 shows a two-stage membrane system in which one permeate stream is sent to a second membrane block while a second permeate stream bypasses the second membrane block.

### DETAILED DESCRIPTION

A two stage membrane system is shown as one of the possible configurations of a multistage membrane system. A gas feed 5 (such as natural gas) is sent to a first-stage membrane block 10 consisting of several membrane elements. A permeate stream 16 is sent to compressor 18 with compressed gas 20 sent to second-stage membrane block 22. Second stage permeate 26 has a high level of helium. A residue stream 12, also referred to as export gas, contains a low level of helium. Recycle stream 14 is in a typical two stage membrane scheme with recycle, also referred to as a closed loop configuration.

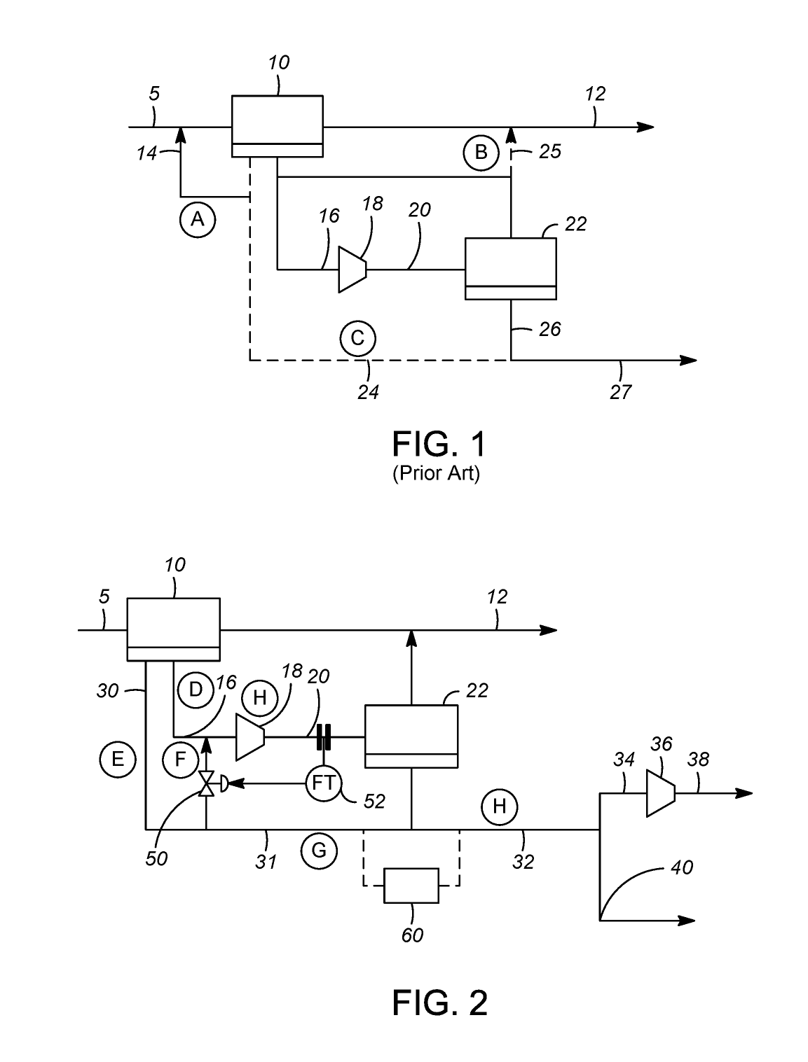

In relation to the present invention it is important to understand two variations that are also shown in FIG. 1. The first variation is using stream 25 instead of, or as a combination with stream 14. A membrane system with a stream 25 is referred to as an open loop configuration. There are two scenarios. First, if the target component concentration in stream 25 is higher than the requirement in the residue stream 12, then the first membrane block 10 will need to remove more of the target component. However, if the target component concentration in stream 25 is equal to the requirement in the residue stream 12, then the first membrane block will also target the same export gas requirement.

A second variation is introducing a second permeate stream from the 1^{st} stage membrane block 10. As shown with stream 24. This is called a pre-membrane configuration. The concentration and pressure level of stream 24 can be different to the concentration and the pressure level of stream 16 that is going to the compressor unit 18. This scheme is mainly used in CO2 and H2S removal applications when one of the following conditions apply. A first condition is that the duty of compressing all of the CO₂ rich permeate gas 16 coming from membrane block 10 is too high and is not beneficial in overall NPV (compression duty vs hydrocarbon recovery). A second condition can be the situation where the second stage permeate gas 27 is flared or incinerated (not reinjected or vented) and hence requires a minimum amount of hydrocarbons to be burned without the need for using assist fuel gas.

Variations can be membrane systems that have features of “two-step”, “three stage”, combinations with downstream separation technologies (Pressure Swing adsorption (PSA), . . . ) with recycle streams from the downstream separation technologies integrated back in the membrane system.

Application: natural gas treating for the removal of components like CO₂, H₂S, water, He, H₂, . . . . Other applications can include the separation of CO₂ from ethane streams.

The invention is a variation to the two-stage membrane system described above.

The invention involves the recovery of helium, the flow adjustment vs. the traditional premembrane configuration and a purity adjustment vs. the prior art traditional configuration.

Unlike acid gas removal applications of carbon dioxide, hydrogen sulfide and other gases, the focus in helium removal/recovery applications is two-fold. Both the natural gas stream (1^{st} stage membrane residue stream 12) and the concentrated helium stream (2^{nd} stage membrane permeate stream 32) are important to the customer

In a traditional premembrane configuration, the flow rate of stream 30 is fixed by the choice of number of premembrane elements in block 10 (typically 1 or 2 membrane elements per tube, sometimes more). As such, the operator has few options to control flow 16 to compressor 18. Once the number of premembrane elements in membrane block 10 is fixed and other degrees of freedom are selected (membrane operating temperature, membrane permeate pressure), the flow of streams 16 and 30 are set.

FIG. 2 shows the differences from the prior art of FIG. 1. A first difference from the prior art is the introduction of a flow control device 52 that will allow to fine tune the operation and match the optimal membrane operation with the optimal compressor 18 operation by controlling the flow 50. This is important since membrane properties are not always easy to predict and tend to change over time.

The membrane can be operated with the same pressure for streams 16 and 30 or with different pressures for streams 16 and 30. In a traditional two stage system with premembrane configuration, the composition of stream 32 is fixed once the parameters (degrees of freedom) in the upstream system have been set (operating temperature and pressure in membrane blocks 10 and 22, the number of premembrane elements in membrane block 10). As such the operator has few options left to control the composition of stream 32 (in this specific application, the composition refers to the helium purity in stream 32 which is feeding the downstream reinjection compressor 36 or other purification units through stream 40. The downstream compression 36 or other purification units 40 may have specific stringent requirements on the helium purity to achieve their performance or avoid operating problems (like condensation during reinjection compression).

A second important feature of the present invention is the introduction of a composition control device 60 that will measure the composition in stream 31 or 32 and control valve 50. This allows the operator to fine tune the operation and match optimal membrane operation with the purity requirements for the permeate 32 which has a high helium concentration. Stream 32 is shown as either proceeding in stream 34 to compressor 36 to possibly being reinjected as stream 38 or sent in stream 40 for further purification such as by pressure swing adsorption or cryogenic treatment.

There are other variations in the operation of the process of this invention. FIG. 2 is shown as an open loop configuration but the principles of the invention can be extended when a closed loop configuration is selected. FIG. 2 is shown as a two-stage membrane system but the ideas can be extended when a single or multistage system is selected. The two-stage membrane system may be integrated with downstream purification steps.

### SPECIFIC EMBODIMENTS

While the following is described in conjunction with specific embodiments, it will be understood that this description is intended to illustrate and not limit the scope of the preceding description and the appended claims.

A first embodiment of the invention is a process of treating a gas stream comprising sending the gas stream through a first membrane module to produce a first and a second permeate streams comprising a higher level of helium than the gas stream and a first residue stream comprising a low level of helium wherein the ratio size of the first permeate stream to the second permeate stream is controlled according by predetermined factors; sending at the first permeate streams to a compressor to produce a compressed permeate stream and sending the second permeate stream to be a helium product stream; sending the compressed permeate stream to a second membrane module to produce a third permeate stream and a second residue stream; and combining the third permeate stream and the helium product stream. An embodiment of the invention is one, any or all of prior embodiments in this paragraph up through the first embodiment in this paragraph wherein the predetermined factor is the capacity of the compressor. An embodiment of the invention is one, any or all of prior embodiments in this paragraph up through the first embodiment in this paragraph wherein the predetermined factor is the desired helium concentration in the combined third permeate stream and the helium product stream. An embodiment of the invention is one, any or all of prior embodiments in this paragraph up through the first embodiment in this paragraph wherein the gas stream is sent through a third membrane module. An embodiment of the invention is one, any or all of prior embodiments in this paragraph up through the first embodiment in this paragraph wherein the residue stream has a helium level that is about one tenth of the helium level of the gas stream. An embodiment of the invention is one, any or all of prior embodiments in this paragraph up through the first embodiment in this paragraph wherein the gas stream is natural gas. An embodiment of the invention is one, any or all of prior embodiments in this paragraph up through the first embodiment in this paragraph wherein the process is at a temperature of about 40° C.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process of treating a gas stream comprising
sending the gas stream through a first membrane module to produce a first and a second permeate streams comprising a higher level of helium than said gas stream and a first residue stream comprising a low level of helium wherein the ratio size of said first permeate stream to said second permeate stream is controlled according by predetermined factors;
sending said first and second permeate streams to a compressor to produce a compressed permeate stream and sending said second permeate stream to be a helium product stream;
sending said compressed permeate stream to a second membrane module to produce a third permeate stream and a second residue stream; and
combining said third permeate stream and said helium product stream.

2. The process of claim 1 wherein said predetermined factor is the capacity of said compressor.

3. The process of claim 1 wherein said predetermined factor is the desired helium concentration in said combined third permeate stream and said helium product stream.

4. The process of claim 1 wherein said gas stream is sent through a third membrane module.

5. The process of claim 1 wherein said residue stream has a helium level that is about one tenth of the helium level of said gas stream.

6. The process of claim 1 wherein said gas stream is natural gas.

7. The process of claim 1 wherein said process is at a temperature of about 40° C.
